(19) United States
(12) Patent Application Publication
(10) Pub. No.: US 2002/0064203 A1
(43) Pub. Date: May 30, 2002

(54) Strip-loaded tunable distributed feedback laser

(76) Inventors: Bardia Pezeshki, Redwood City, CA (US); Vincent Wong, San Jose, CA (US)

Correspondence Address: HARNESS, DICKEY & PIERCE, P.L.C., P.O. BOX 828, BLOOMFIELD HILLS, MI, 48303, US

(21) Appl. No.: 09/951,895

(22) Filed: Sep. 13, 2001

Related U.S. Application Data
(60) Provisional application No. 60/232,962, filed on Sep. 14, 2000.

(51) Int. Cl. H01S 3/03

(52) U.S. Cl. 372/64

(57) ABSTRACT

A semiconductor laser with single longitudinal mode includes active region(s) and phase shift region(s). An optical cavity such as a passive waveguide extends through the active region(s) and the phase shift region(s). A diffraction grating in the active region(s) has a refractive index. An active layer in the active regions is located between the diffraction grating and the passive waveguide. The phase shift region(s) have a refractive index difference Δn with respect to the index of the active region(s). The phase shift region(s) are located adjacent to and/or between the active region(s). An optical mode is shifted in the phase shift region. An eletro-optical circuit tunes a lasing wavelength of the laser by varying Δn. The electro-optical circuit reverse or forward biases a tuning junction to change the refractive index difference Δn using field effects or carrier effects.

### CROSS-REFERENCE TO RELATED APPLICATIONS

This application claims the benefit of U.S. Provisional Application No. 60/232,962, filed Sep. 14, 2000.

### FIELD OF THE INVENTION

The present invention relates to semiconductor laser diodes, and more particularly to semiconductor laser diodes with single frequency characteristics such as distributed feedback (DFB) lasers.

### BACKGROUND OF THE INVENTION

The most basic design of a semiconductor laser is known as a Fabry-Perot laser that includes two mirrors and an active layer or optical cavity made of semiconductor material that is located between the mirrors. An electric current is applied to the active layer and light is emitted in the active layer. Light travels through the active layer until it reaches a reflective end. Most of the light is reflected back through the active layer, which stimulates the emission of light. A rear reflective end typically internally reflects close to 100% of the light, while a front reflective end typically internally reflects around 10% percent of the light.

When the light builds up enough energy within the active layer, a highly intense beam of light is emitted from the front end of the laser. At the threshold current, stimulated emission occurs. For many materials, such as InP-based lasers used for telecommunications, the light is generated at multiple wavelengths, governed by the longitudinal modes of the cavity. Since light is generated at multiple wavelengths, the laser is not useful for long-distance and high-speed communications because the different wavelengths travel through the fiber at different speeds and interferes with other modulated data on the light beam.

The average lasing wavelength of Fabry-Perot lasers is determined solely by the maximum gain. Since the gain bandwidth of semiconductor lasers is broad, the wavelength selectivity is usually relatively low. Consequently, Fabry-Perot lasers frequently operate multimode and/or exhibit random longitudinal mode hopping, both of which are not acceptable for most applications.

The multiple-wavelength output of Fabry-Perot lasers is also undesirable in many applications. For example, when different wavelengths are transmitted down the same optical fiber in wavelength-division multiplexed (WDM) systems, the stray wavelengths of the Fabry-Perot lasers interfere with other adjacent signals. Distributed feedback (DFB) lasers solve this problem by significantly reducing the undesired wavelengths.

Referring now to FIG. 1A, a distributed feedback DFB laser according to the prior art is illustrated and is generally designated 10. Opposite edges of the DFB laser 10 typically include antireflective coatings 12 and 14. The DFB laser 10 includes an active layer or optical cavity 16 that is located between the upper and lower cladding layers 18 and 20. The DFB laser 10 also includes a corrugated waveguide 22. While eliminating undesired wavelengths, the DFB laser 10 has an inherent flaw in that it frequently operates simultaneously with two longitudinal optical modes. FIG. 1B illustrates the calculated spontaneous emission spectrum of the DFB laser 10. FIG. 1C. Illustrates the measured spectrum of the DFB laser 10. Both the measured and calculated spectra demonstrate the two optical modes of the DFB laser 10.

The refractive index and the spacing of the corrugated waveguide 22 serve to reflect only a specific wavelength of light. The corrugated waveguide 22 acts as a grating and reflects only a specific wavelength back into the active layer 16 while allowing other wavelengths to pass through. The DFB laser 10 is distributed because the corrugated waveguide 22 feeds back the desired wavelength into the active layer 16 along the length of the DFB laser 10. The light that builds up within the active layer 16 is light of the selected wavelength, which is emitted from the ends of the DFB laser 10. Examples of DFB lasers are described in U.S. Pat. No. 5,208,824 to Tsang, which is hereby incorporated by reference.

The manufacturing yield of DFB lasers is relatively poor since there are two degenerate modes that are associated with a uniform grating. Asymmetric highly reflective (HR) and antireflective (AR) coatings that are applied to the facets sometimes remove the degeneracy. This process, however, does not provide a high yield because the cleave occurs at a random point in the grating and introduces a random phase shift. The value of this random phase shift determines whether the laser is single mode or the value of the side mode suppression ratio (SMSR).

Other conventional methods for removing the degeneracy to provide single mode operation employ a quarter-wave shift in the grating as disclosed in “Quarter-Wave-Shifted InGaAsP/InP DFB Lasers”, IEEE J. of Quantum Electronics, QE-22(7), pp. 1042-1051 (July 1986), which is hereby incorporated by reference. The grating on one side of the laser is 90 degrees out of phase with respect to the grating on the other side of the laser. The phase shifts are very difficult to produce holographically and generally require the use of electron-beam lithography.

Another method employs a grating and gain or loss instead of index. In these complex-coupled DFB lasers, one of the modes has a much higher overlap with the gain than the other mode. As a result, the laser exhibits excellent single mode characteristics. Unfortunately, this method involves etching through the gain region and regrowing. This method is technically complex and may lead to the introduction of defects that impact reliability. U.S. Pat. No. 5,452,318 to Makino et al. describes a complex-coupled DFB laser. U.S. Pat. No. 6,104,739 to Hong et al. describes a DFB laser that can be employed as a tunable source.

Another approach described by F. Koyama in “1.5 μm Phase Adjusted Active Distributed Reflector Laser For Complete Dynamic Single Mode Operation”, Electronics Letters, Vol. 20, p. 391-393 (1984), hereby incorporated by reference, includes an area in the lasing cavity where the propagation constant of the light is changed. As the light moves along the cavity, a phase difference occurs between the light and the grating. By suitably changing the propagation constant of the light and the length of this region, a quarter-wave phase shift can be achieved. Koyama achieves the phase shift by not etching a grating in the central region. H. Soda et al. achieves a similar result, as described in “GaInAsP/InP Phase Adjusted Distributed Feedback Lasers with a Step-Like Non-Uniform Stripe Width Structure”, Electronics Letters, Vol. 20, p. 1016-1018 (1984), hereby incorporated by reference, by changing the width of the lasing stripe.

### SUMMARY OF THE INVENTION

A semiconductor laser according to the invention with a single longitudinal mode includes a first active region and a phase shift region having a length L. An optical cavity extends through the first active region and the phase shift region. A first diffraction grating in the first active region has a first modal refractive index n1. The phase shift region has a second modal refractive index n2 defining a refractive index difference Δn.

In other features of the invention, n1Δn is equal to +/−¼λm/L where m is an odd number. The semiconductor laser further includes a second active region. A second diffraction grating is located in the second active region and has the first modal refractive index. A second active layer extends along the second active region.

The phase shift region includes a third diffraction grating or no diffraction grating at all. The phase shift region is located between the first and second active regions or adjacent to one of the facets of the laser. The second modal refractive index of the phase shift region is different than the first modal refractive index of the first and second active regions. The difference in the two indices causes a quarter-wave shift between the gratings in the first and second active regions and the optical mode.

To allow tunability, an electro-optical circuit tunes a lasing wavelength of the laser by changing the modal refractive index of the phase shift region. The electro-optical circuit reverse biases a tuning junction to change the refractive index using field effects or forward biases the tuning junction to change the refractive index using carrier effects.

Further features and areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A illustrates a conventional distributed feedback (DFB) laser that operates with two optical modes simultaneously;

FIG. 1B illustrates a calculated spontaneous emission spectrum for the DFB laser of FIG. 1A;

FIG. 1C. illustrates a measured spectrum for the DFB laser of FIG. 1A;

FIG. 2 illustrates a cross-sectional view of a DFB laser according to the present invention with wavelength tuning capability;

FIG. 3 illustrates a schematic of a strip-loaded DFB laser with the phase shift region having a different effective refractive index than diffraction gratings in active regions that are adjacent thereto;

FIG. 4 illustrates the calculated spectra of the DFB laser of FIG. 3 with 90, 100, and 110 μm grating blocks

FIG. 5 illustrates the spectra of strip-loaded and unloaded DFB lasers; and

FIG. 6 illustrates the experimental continuous wave (CW) spectrum of a phase-shifted DFB laser.

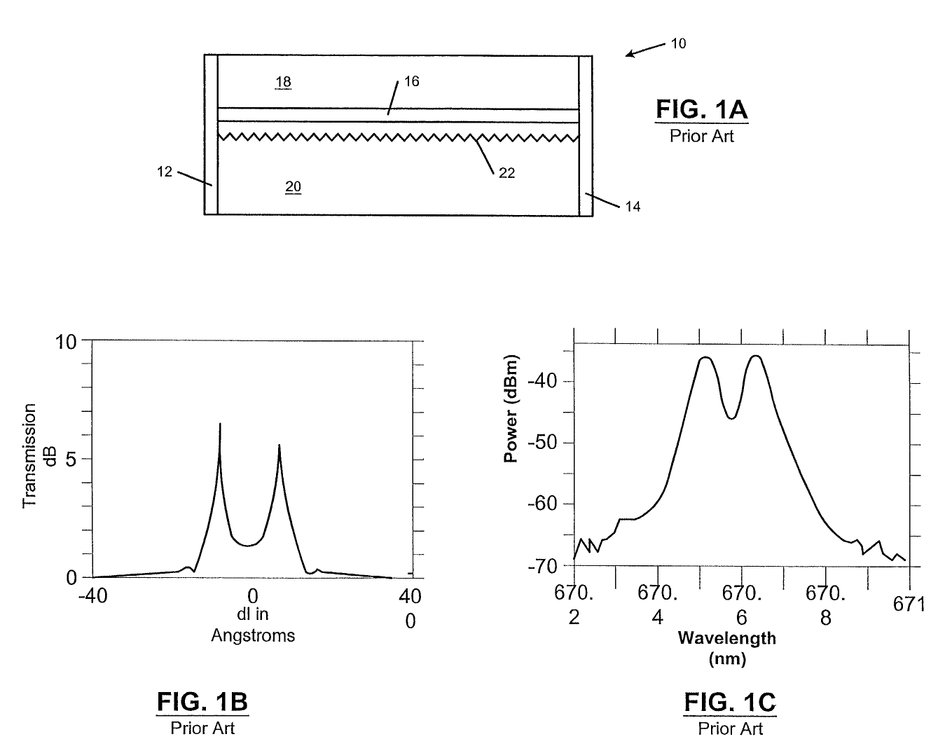

### DETAILED DESCRIPTION OF THE PREFERRED EMBODIMENTS

The following description of the preferred embodiment(s) is merely exemplary in nature and is in no way intended to limit the invention, its application, or uses.

According to the present invention, a new structure and method for shifting a phase of a diffraction grating in the optical cavity of a DFB laser is presented for obtaining tunability. The DFB laser according to the present invention can be fabricated using conventional holographic lithography. Rather than shifting the phase of the grating from one side of the cavity to the other, the phase of the optical mode that propagates in the optical cavity is shifted. By adjusting the refractive index in the region between the two gratings, the laser can be tuned.

In one exemplary embodiment, the shift is obtained by having one or more phase shift regions in the DFB laser optical cavity that have an effective refractive index that is different than the effective refractive index in adjacent active regions with diffraction gratings. When the optical field passes through these regions, the optical field undergoes phase shift. The laser wavelength can then be adjusted or tuned by varying the optical length of the region using electro-optical techniques such as carrier effects or field effects.

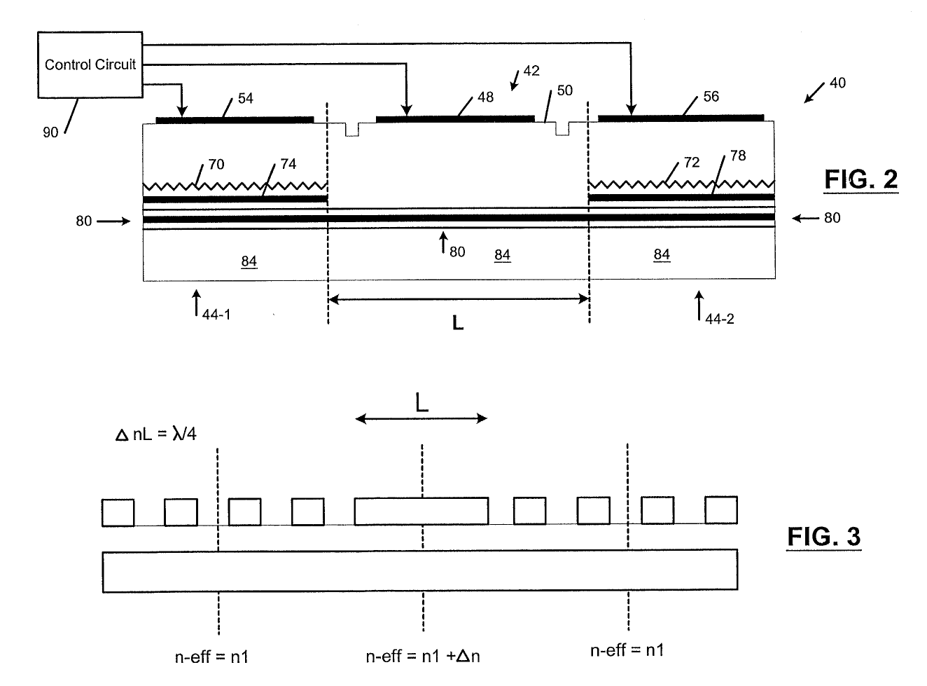

Referring now to FIG. 2, a DFB laser 40 according to a first exemplary embodiment of the present invention is illustrated. The DFB laser 40 includes one or more phase shift region(s) 42-1, . . . , 42-n and adjacent active regions 44-1, . . . , 44-m. In the exemplary embodiment, a single phase shift region 42 is centrally located between two outer active regions 44-1 and 44-2. The DFB laser 40 includes a tuning contact 48 on an outer surface 50 of the DFB laser 40 in the phase shift region 42. The DFB laser 40 includes gain contacts 54 and 56 on the outer surface 50 of the DFB laser 40 in the adjacent active regions 44-1 and 44-2, respectively.

Diffraction gratings 70 and 72 are located in the active regions 44-1 and 44-2, respectively. Quantum well (QW) active layers 74 and 78 are located adjacent to the diffraction gratings 70 and 72 in the active regions 44-1 and 44-2, respectively. A passive waveguide region 80 contains quantum wells and extends the length of the DFB laser 40. The passive waveguide region 80 is supported by a substrate 84. As can be appreciated, antireflective coatings (not shown) can be formed at opposite facets of the DFB laser 40 if desired. A control circuit 90 is connected to the gain contacts 54 and 56 and the tuning contact 48.

Referring now to FIG. 3, the first and second active regions 44-1 and 44-2 have a modal refractive index of n1. The phase shift region 42 has a second modal refractive index of n2. A quarter-wave shift between the diffraction grating and the optical mode is obtained when the effective index of the optical mode is changed by Δn=absval(n1−n2) in the phase shift region(s) 42 for a given distance L such that Δn*L/λ=¼m where m is an odd number. The diffraction gratings 70 and 72 on opposite sides of the phase shift region 42 are still in phase with each other. Only the phase of the optical mode has been changed. In an exemplary embodiment, the change Δn in the effective refractive index of the optical mode can be achieved by simply not forming a grating in the phase shift region 42 where a phase shift is required. By not etching the grating in the phase shift region 42, the phase shift region 42 contains more of a material with a high refractive index and the effective refractive index will change by Δn. The total desired phase shift is obtained by adjusting the length L of the phase shift region(s) 42 based on the relationship that is set forth above. As can be appreciated by skilled artisans, instead of a single phase shift region 42 having a length L and a phase shift of ¼ wavelength, the DFB laser 40 can include n phase shift regions 42-1, . . . , 42-n each with a length of L/n and a phase shift of ¼n. The summed total of the n phase shift regions 42 is L and the phase shift is ¼.

Alternately, the sum total of the phase shift regions 42-1, . . . , 42-n can equal ¼m where m is an odd number. In other words, Δn*L/λ=¼m where m is an odd number and where L is the sum total of the length of the phase shift regions 42. In an exemplary embodiment, a first phase shift region 42-1 has an effective optical mode index change of Δn₁ and a length L₁, a second phase shift region 42-2 has an effective optical mode index change of Δn₂ and a length L₂, and an n^{th} phase shift region 42-n has an effective optical mode index change of Δnₙ and a length Lₙ where Δn₁L₁+Δn₂L₂+ . . . +ΔnₙLₙ=¼m and where m is an odd number.

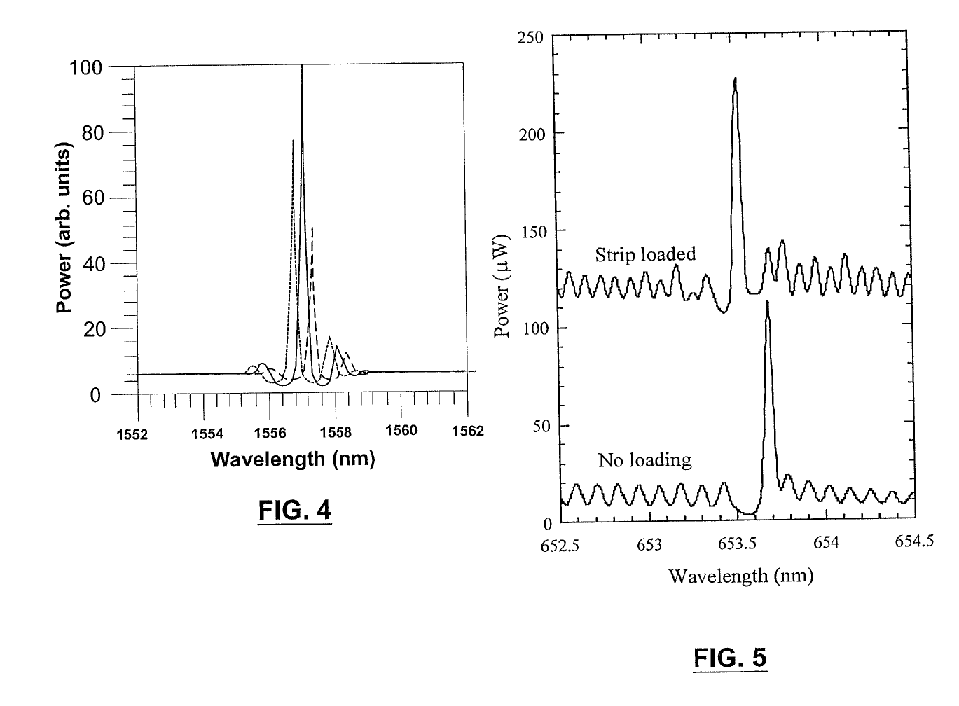

Referring now to FIG. 4, the modal characteristics of the DFB laser 40 can be calculated using the transfer matrix approach. FIG. 4 illustrates a calculation for a longer wavelength telecommunications laser. In this case, the diffraction grating is not etched in the phase shift region 42 of the DFB laser 40 to increase the refractive index slightly. As can be seen in FIG. 4, for the value of 100 μm, the lasing wavelength occurs in the center of the stop band corresponding to a quarter-wave shift.

Other methods for obtaining the index difference Δn are contemplated by the present invention. For example, an index difference Δn in the phase shift region of the cavity can also be obtained by completely or partially removing the grating layer, adding an implant or diffusion processing step, and/or having an extra layer that increases the refractive index of the mode. Additionally, there is no requirement to remove the diffraction grating from the phase shift region. Rather, a change in the effective refractive index of the optical mode is the only requirement.

The phase shift region 42 (providing a quarter-wave shift) can be placed in other positions in the optical cavity. For example, by placing the single phase shift region 42 towards the front of the DFB laser 40, higher power will be emitted from one facet than the other facet of the DFB laser 40 thereby improving the external efficiency of the DFB laser 40. Alternatively, rather than having the single phase shift region 42, a plurality of smaller phase shift regions 42-1, . . . , 42-n can be provided in the cavity as previously discussed above. Multiple smaller phase shift regions 42 will render the intensity profile more uniform and reduce spatial hole burning.

The phase shift region 42 can also be positioned at the end of the cavity if a highly reflective (HR) coating (not shown) is employed at the end of the cavity. This structure resembles a Distributed Bragg Reflector (DBR) laser. In the DBR structure, however, the section without the grating is pumped while the grating section is passive (not pumped). In the present invention, however, the QW active layers 74 and 78 located adjacent to the gratings 70 and 72 are pumped and the phase shift region(s) 42 without gratings are passive (not pumped).

Three different visible wavelength DFB lasers were fabricated to test the present invention. The first laser had a continuous grating in the cavity, the second laser had a 25 μm region with no grating, and the third laser had a 50 μm region with no grating. According to calculations, the third laser with the 50 μm region corresponds to a half-wave shift and the second laser is optimally shifted and has a peak in the center of the grating stop band.

The spectra of the resulting DFB lasers were monitored and the position of the optical mode with respect to the stop band was measured. The spectra of the first and third lasers were nearly identical. The first and third lasers have a peak at the edge of the stop band. The second laser, on the other hand, exhibited a peak at the center of the stop band. In FIG. 5, the spectrum of the first laser with no phase shift (no loading) and the second laser with 25 μm shift (strip load) are shown. As predicted, the first laser has a peak at the edge of the stop band and the second laser has a peak at the center of the stop band.

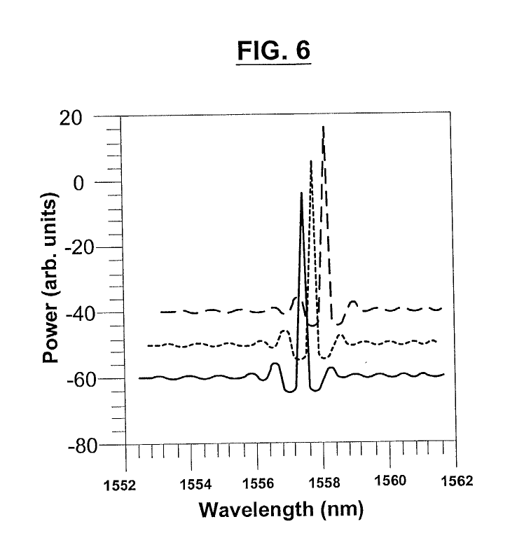

Referring now to FIG. 6, the lasing wavelength depends on the refractive index of the phase shift region(s) 42. The peak shifts in the stop band because carriers are being depleted more in the center region than in the rest of the cavity. As the carriers decrease, the refractive index increases and the peak moves to the longer wavelength side of the stop band. This sensitivity to the refractive index of the phase shift region(s) 42 allows the DFB laser 40 to be tuned.

The phase shift region(s) 42 of the DFB laser 40 are passive and the refractive index can be tuned by varying the applied electric field (e.g. the voltage or the current in the region using the control circuit 90). By varying the electric field, the phase shift of the optical mode can be tuned. If carrier effects are employed, then the center region 42 is forward biased and carriers are injected into an intrinsic layer without gain at the wavelength of interest. The changing carrier density varies the refractive index and modulates the wavelength of the DFB laser 40 without substantially changing the light intensity of the DFB laser 40.

Alternately, field effects can be used to tune the DFB laser 40 by reverse biasing the phase shift region(s) 42. Quantum wells are placed in the phase shift region 42 where the band edge would be slightly above the lasing wavelength. Reverse biasing the junction causes the refractive index to change through the Franz-Keldysh or Quantum Confined Stark Effect. With sufficient index modulation, the lasing wavelength can be varied across the stop band to obtain over several nm of tuning range. Closer to the edge of the stop band, the side mode suppression ratio increases due to competition from the other optical mode that is positioned on the other side of the stop band. The DFB laser 40 can be tuned rapidly and provides significant utility in FM modulated telecommunications links, RF photonics application and other devices requiring high speed tuning.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A semiconductor laser with a single longitudinal mode, comprising:
a first active region;
a phase shift region having a length L;
a passive waveguide in said first active region and said phase shift region;
a first diffraction grating in said first active region having a first refractive index;
a first active layer in said first active region and located between said first diffraction grating and said passive waveguide, wherein said phase shift region has a refractive index difference Δn; and
an electro-optical circuit that tunes a lasing wavelength of said laser by varying said refractive index difference Δn.

2. The semiconductor laser of claim 1 wherein Δn is equal to +/−¼λm/L where m is an odd number.

3. The semiconductor laser of claim 1 wherein said phase shift region does not include a diffraction grating.

4. The semiconductor laser of claim 1 further comprising:
a second active region;
a second diffraction grating in said second active region and having a second refractive index; and
a second active layer in said second active region and located between said second diffraction grating and said passive waveguide.

5. The semiconductor laser of claim 1 wherein said phase shift region includes a third diffraction grating having a third refractive index.

6. The semiconductor laser of claim 4 wherein said phase shift region is located between said first and second active regions.

7. The semiconductor laser of claim 1 wherein said phase shift region is located adjacent to one facet of said laser.

8. The semiconductor laser of claim 1 wherein said electro-optical circuit reverse biases a tuning junction to change said refractive index difference Δn using field effects.

9. The semiconductor laser of claim 1 wherein said electro-optical circuit forward biases a tuning junction to change said refractive index difference Δn using carrier effects.

10. The semiconductor laser of claim 1 wherein said first active layer includes quantum wells.

11. The semiconductor laser of claim 1 wherein said passive waveguide includes quantum wells.

12. The semiconductor laser of claim 1 wherein said first active layer is pumped.

13. The semiconductor laser of claim 4 wherein said first and second diffraction gratings are in phase.

14. A semiconductor laser with a single longitudinal mode, comprising:
first and second active regions;
a phase shift region having a length L;
a passive waveguide;
a first diffraction grating in said first active region having a first refractive index;
a second diffraction grating in said second active region having a second refractive index, wherein said first and second diffraction gratings are substantially in phase;
a first active layer in said first active region and located between said first diffraction grating and said passive waveguide;
a second active layer in said second active region and located between said second diffraction grating and said passive waveguide wherein said phase shift region has a refractive index difference Δn with respect to said first and second refractive indexes, and
an eletro-optical circuit that tunes a lasing wavelength of said laser by varying said refractive index difference Δn.

15. The semiconductor laser of claim 14 wherein Δn=+/−¼λm/L where m is an odd number.

16. The semiconductor laser of claim 14 wherein said phase shift region does not include a diffraction grating.

17. The semiconductor laser of claim 14 wherein said phase shift region includes a third diffraction grating having a third refractive index.

18. The semiconductor laser of claim 14 wherein said phase shift region is located between said first and second active regions.

19. The semiconductor laser of claim 14 wherein said electro-optical circuit reverse biases a tuning junction to change said refractive index difference Δn using field effects.

20. The semiconductor laser of claim 14 wherein said electro-optical circuit forward biases a tuning junction to change said refractive index difference Δn using carrier effects.

21. A semiconductor laser device that generates a single longitudinal optical mode, comprising:
an optical cavity;
a first active region located along said optical cavity adjacent to one facet of said laser that includes a first diffraction grating and a first active layer; and
a phase shift region located along said optical cavity that has an effective refractive index that is different than a refractive index of said first active region thereby creating a phase shift between said longitudinal optical mode and said first grating.

22. A semiconductor laser that generates a single longitudinal optical mode, comprising:
an optical cavity;
a first active region located along said optical cavity that includes a first diffraction grating and a first active layer;
a phase shift region that has a length L and that is located along said optical cavity, wherein said phase shift region has an effective refractive index difference Δn=+/−¼λm/L where m is an odd number; and
an eletro-optical circuit that tunes said lasing wavelength of said laser.

23. The semiconductor laser of claim 22 wherein said phase shift region does not include a diffraction grating.

24. The semiconductor laser of claim 22 further comprising a second active region with a second diffraction grating and a second active layer.

25. The semiconductor laser of claim 22 wherein said phase shift region includes a third diffraction grating having a third refractive index.

26. The semiconductor laser of claim 24 wherein said phase shift region is located between said first and second active regions.

27. The semiconductor laser of claim 22 wherein said phase shift region is located adjacent to one facet of said laser.

28. The semiconductor laser of claim 22 wherein said electro-optical circuit reverse biases a tuning junction of said laser to change said refractive index difference Δn using field effects.

29. The semiconductor laser of claim 22 wherein said electro-optical circuit forward biases a tuning junction of said laser to change said refractive index difference Δn using carrier effects.

30. The semiconductor laser of claim 22 wherein said first active layer includes quantum wells.

31. The semiconductor laser of claim 22 wherein said optical cavity includes a passive waveguide with quantum wells.

32. The semiconductor laser of claim 22 wherein said first active layer is pumped.

33. A semiconductor laser that generates a single longitudinal mode, comprising:
a plurality of active regions each including a diffraction grating and an active layer, wherein said diffraction gratings have a first refractive index and are in phase;
a plurality of phase shift regions having a summed length L, wherein said active regions and said phase shift regions alternate and said phase shift regions have a refractive index difference Δn with respect to said active regions; and
an optical cavity extending through said phase shift regions and said active regions, wherein said refractive index difference Δn imposes a phase shift on said longitudinal optical mode.

34. The semiconductor laser of claim 33 further comprising an electro-optical circuit that tunes a lasing wavelength of said laser by varying said refractive index difference Δn of said plurality of phase shift regions.

35. The semiconductor laser of claim 33 wherein Δn is equal to +/−¼λm/L where m is an odd number.

36. The semiconductor laser of claim 33 wherein said phase shift region does not include a diffraction grating.

37. The semiconductor laser of claim 34 wherein said electro-optical circuit reverse biases a tuning junction to change said refractive index difference Δn using field effects.

38. The semiconductor laser of claim 34 wherein said electro-optical circuit forward biases a tuning junction to change said refractive index difference Δn using carrier effects.

39. The semiconductor laser of claim 33 wherein said active layers include quantum wells.

40. The semiconductor laser of claim 33 wherein said optical cavity includes a passive waveguide with quantum wells.

41. The semiconductor laser of claim 33 wherein said active layers are pumped.
